(19) United States
(12) Patent Application Publication
(10) Pub. No.: US 2024/0076004 A1
(43) Pub. Date: Mar. 7, 2024

(54) ELECTRIC BICYCLE HAVING A DRIVE BATTERY AND A DRIVE BATTERY ASSEMBLY FOR AN ELECTRIC BICYCLE

(71) Applicant: BIKETEC GmbH, Huttwil (CH)

(72) Inventors: Lingfei HE, Offenbach am Main (DE); Chuanyu ZHANG, Shanghai (CN)

(73) Assignee: Biketec GmbH, Huttwil (CH)

(21) Appl. No.: 18/090,877

(22) Filed: Dec. 29, 2022

(30) Foreign Application Priority Data
Sep. 7, 2022 (DE) 202022105039.2

(51) Int. Cl. B62J 43/28; B62M 6/90

(52) U.S. Cl. CPC B62J 43/28; B62M 6/90

(57) ABSTRACT

The invention relates to an electric bicycle (1) having a bicycle frame (2) and a drive battery (6) which can be fastened thereto, wherein a primary locking arrangement of the drive battery (6) on the bicycle frame (2) is provided by means of a lock (10), wherein, after actuation of the lock (10), the drive battery (6) can be moved to an intermediate position, and with a secondary locking arrangement (16) which fixes the drive battery (6) in the intermediate position, characterized in that the secondary locking arrangement (16) can be actuated to a removal position in order to remove the drive battery (6) by means of a relative movement of the drive battery (6) relative to the bicycle frame (2).

The present invention relates to an electric bicycle according to the preamble of claim 1 and to a drive battery assembly for an electric bicycle according to the preamble of claim 24.

Electric bicycles, such as e.g. E-bikes, having electric motor assistance are known from the prior art and have a removable drive battery, at least sections of which are accommodated in the bicycle frame. The drive battery can be fastened e.g. in a frame-side holder of a down tube of the bicycle frame. For this purpose, the drive battery is inserted from below or, according to an alternative design, from above into the frame-side battery holder, wherein a primary locking arrangement of the drive battery on the frame is provided by means of a lock.

In order to remove the drive battery from the bicycle frame, the lock is actuated by the rider e.g. by means of a key, and the drive battery is moved to an intermediate position. In the partially pivoted-out intermediate position, the drive battery is secured against falling out by means of a second locking bar which is provided as a secondary locking arrangement and has a latching hook. The drive battery is then held by the rider using one hand and the second locking bar is actuated using the other hand in order to be able to completely unlock and remove the drive battery.

A disadvantage of this solution is that, in order to remove the drive battery, it has to be held by the rider using one hand and the second locking bar has to be actuated using the other hand. The provision of a second locking bar is also complex in terms of manufacturing technology.

Therefore, the object of the invention is to provide an electric bicycle having a drive battery and a drive battery assembly for an electric bicycle which permits rapid, simple mounting and demounting of the drive battery.

This object is achieved by means of an electric bicycle having the combination of features of claim 1 and by means of a drive battery assembly for an electric bicycle as claimed in claim 24.

The electric bicycle in accordance with the invention has a bicycle frame and a drive battery which can be fastened thereto, wherein a primary locking arrangement of the drive battery on the frame is provided by means of a lock, wherein, after actuation of the lock, the drive battery can be moved to an intermediate position, and with a secondary locking arrangement which fixes the drive battery in the intermediate position. In accordance with the invention, the secondary locking arrangement can be actuated to a removal position in order to remove the drive battery by means of a relative movement of the drive battery relative to the bicycle frame. The drive battery is now completely unlocked and can be removed from or taken off the bicycle frame. In this case, it is advantageous that the drive battery can be removed by the rider using one hand. The rider can use their other hand e.g. to hold the bicycle while removing the battery. A second locking bar which is complex in terms of manufacturing technology is not required.

It has proven to be particularly advantageous if the secondary locking arrangement is provided by means of a secondary locking bar which is guided in a guide track or a guide link.

According to a preferred embodiment of the electric bicycle, the secondary locking arrangement is unlocked after actuation of the primary locking arrangement by means of a movement of the drive battery in the direction opposite its removal direction. In this case, the drive battery is moved by the rider preferably from the intermediate position, i.e. after unlocking of the lock, at least partially back into the bicycle frame. As a result, the secondary locking arrangement is unlocked and the drive battery can then be removed.

In the case of an alternative embodiment of the invention, the secondary locking arrangement is unlocked after actuation of the primary locking arrangement by the lock by means of a movement of the drive battery in its removal direction. In this case, the rider preferably pulls the drive battery, overcomes a holding resistance, e.g. of a latching hook, ball catch or the like, in so doing, and removes the drive battery.

The guide track is designed preferably as a guide slot or pocket-like groove. In the case of a preferred variant in accordance with the invention, the guide track is provided as a guide slot in an end plate mounted on the drive battery housing. The end plate is screwed to the drive battery housing preferably on the end face.

According to a further exemplified embodiment, the guide track is provided on the frame side, i.e. is allocated to the bicycle frame.

The secondary locking bar is designed preferably as a locking pin which is cylindrical at least in sections.

In accordance with the invention, the guide track forms preferably bistable positions for the secondary locking bar. Preferably, the guide track is designed as a heart-shaped track.

Preferably, the guide track has a lower end position and an upper end position for the secondary locking bar.

The secondary locking bar is located in the lower end position of the guide track when the drive battery is completely locked and arranged in its operating position. During mounting of a removed drive battery, the secondary locking bar is moved along the guide track to this lower end position.

After opening of the lock, the drive battery is moved preferably to an intermediate position, in which the secondary locking bar is located in an upper end position of the guide track.

The secondary locking bar can be moved by means of a movement of the drive battery relative to the intermediate position, preferably to a removal position of the guide track.

In this case, it has proven to be particularly advantageous if the secondary locking bar can be moved laterally in the guide track by reason of an application of force, preferably by means of the force of at least one elastic element, particularly preferably a spring, and reaches a removal track section of the guide track. After opening of the lock, the drive battery is moved preferably to an intermediate position, in which the secondary locking bar is located in an upper end position of the guide track. In this case, the secondary locking bar has been prevented, preferably by means of a stop element, from deflecting by reason of the spring bias.

Preferably, the removal track section extends in the removal direction of the drive battery.

According to a preferred embodiment of the electric bicycle, the guide track is triangular in sections and has a vertical guide track region as well as a lower transition region and an upper transfer region.

In the case of an alternative variant of the invention, the guide track is approximately W-shaped at least in sections. Preferably, the guide track is designed as a heart-shaped curve, in particular as an inverse heart-shaped curve.

Preferably, the secondary locking bar has a force applied thereto in the direction of the transfer region.

Preferably, the secondary locking bar is acted upon in the direction of the transfer region by means of the force of at least one elastic element, preferably a spring.

In the case of an alternative preferred embodiment variant, the guide track is arranged in a pivotable manner. Preferably, the guide track is allocated to a locking element which can be pivoted about a pivot point and has a spring force applied thereto.

In the case of a preferred embodiment of the electric bicycle, the guide track is arranged next to an engagement point of the lock.

In the case of a particularly preferred exemplified embodiment, the guide track is allocated to the drive battery.

The drive battery has preferably an end section which can be pivotably inserted in the bicycle frame, wherein the guide track is formed on an end section opposite to the pivotable end section.

Alternatively, the guide track is formed preferably on the frame side.

According to a preferred embodiment of the electric bicycle, the drive battery can be pivoted into a lower side of the down tube. The drive battery can be pivoted preferably completely into the frame tube, e.g. the down tube.

A drive battery assembly in accordance with the invention for an electric bicycle having a bicycle frame and a drive battery which can be fastened thereto has a primary locking arrangement of the drive battery on the frame by means of a lock, wherein, after actuation of the lock, the drive battery can be moved to an intermediate position, and with a secondary locking arrangement which fixes the drive battery in the intermediate position. In accordance with the invention, the secondary locking arrangement can be actuated to a removal position and thereby unlocked in order to remove the drive battery by means of a relative movement of the drive battery relative to the bicycle frame.

In a particularly advantageous manner, the battery assembly in accordance with the invention is suitable for universal mounting on differently designed bicycle frames.

Further preferred embodiments are described in the dependent claims.

Three preferred embodiments of the present invention are explained in greater detail hereinafter with reference to the accompanying drawings. In detail, in the drawings:

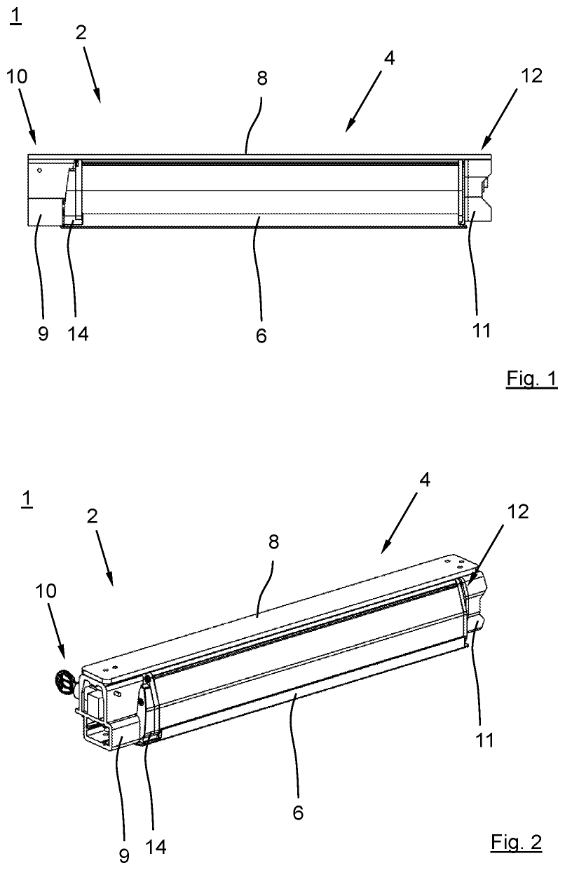

FIG. 1 shows a side view from the left of an electric bicycle in accordance with the invention in the region of the drive battery;

FIG. 2 shows a perspective view of the electric bicycle of FIG. 1 in the region of the drive battery;

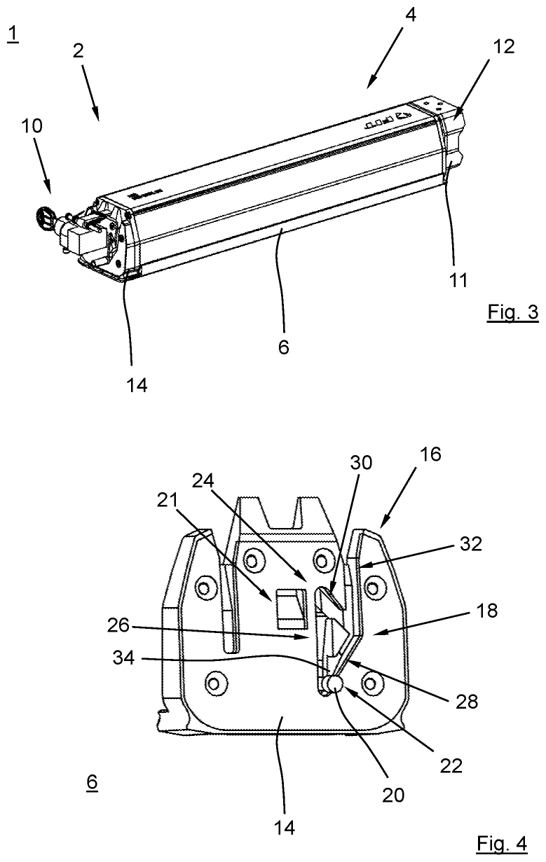

FIG. 3 shows a further perspective view of the electric bicycle of FIG. 1 in the region of the drive battery;

FIG. 4 shows an individual view of the end plate of the drive battery;

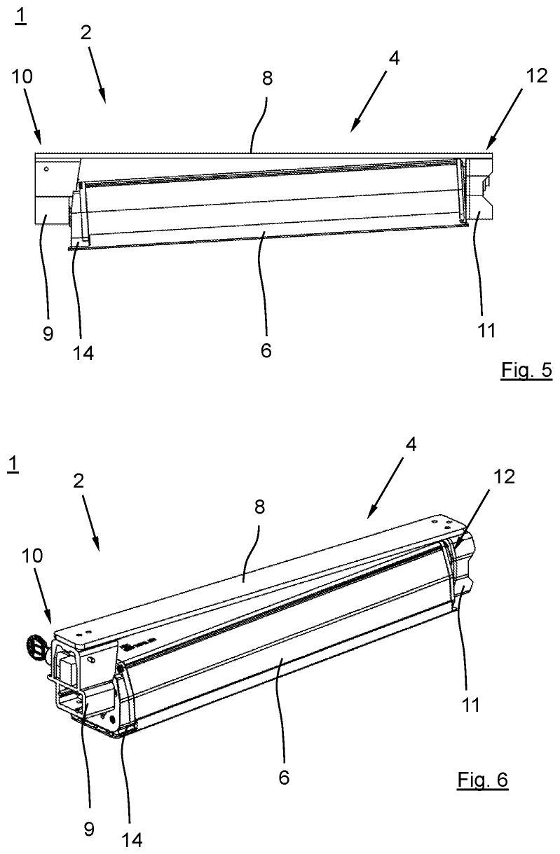

FIG. 5 shows a side view from the left of an electric bicycle in accordance with the invention in the region of the drive battery in the intermediate position;

FIG. 6 shows a perspective view of the electric bicycle of FIG. 5 in the region of the drive battery in the intermediate position;

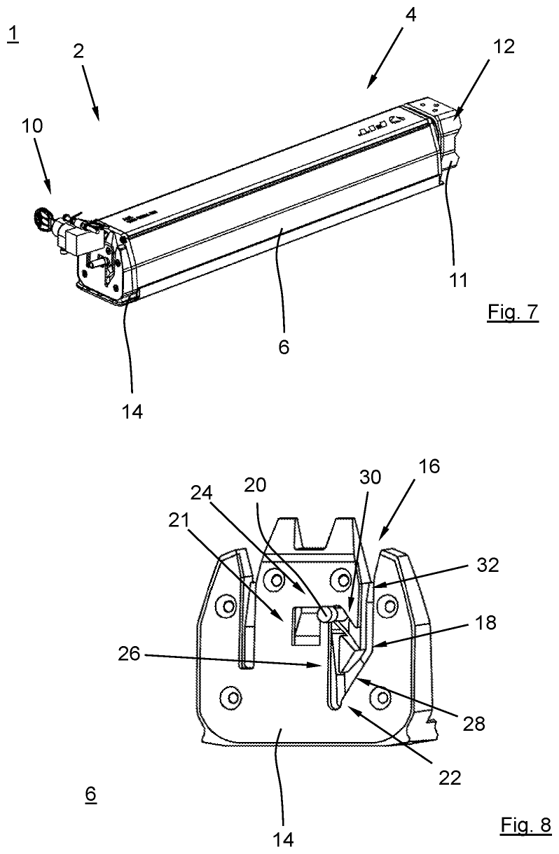

FIG. 7 shows a further perspective view of the electric bicycle of FIG. 5 in the region of the drive battery in the intermediate position;

FIG. 8 shows an individual view of the end plate of the drive battery in the intermediate position;

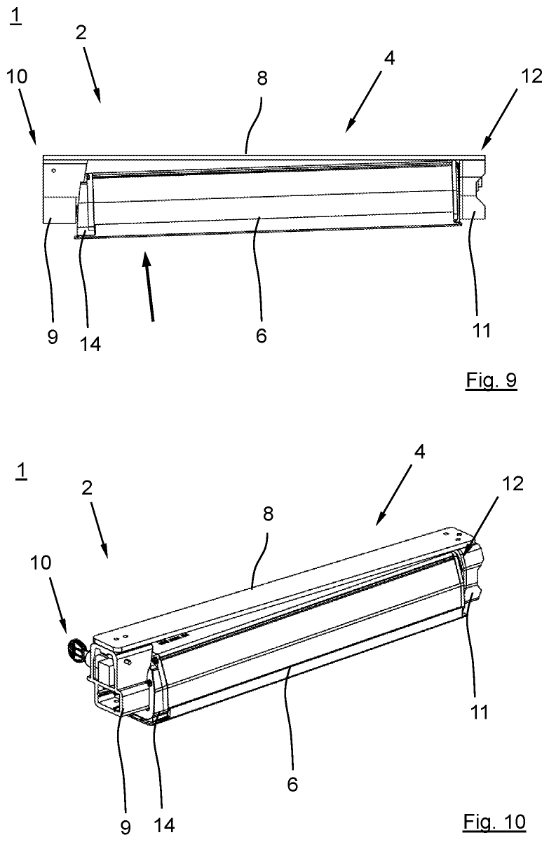

FIG. 9 shows a side view from the left of an electric bicycle in accordance with the invention in the region of the drive battery in the removal position;

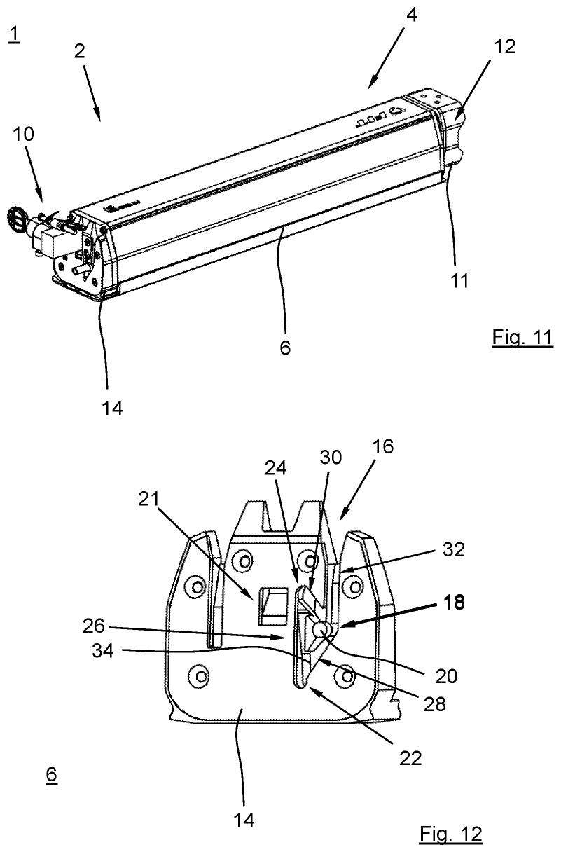

FIG. 10 shows a perspective view of the electric bicycle of FIG. 9 in the region of the drive battery in the removal position;

FIG. 11 shows a further perspective view of the electric bicycle of FIG. 9 in the region of the drive battery in the removal position;

FIG. 12 shows an individual view of the end plate of the drive battery in the removal position;

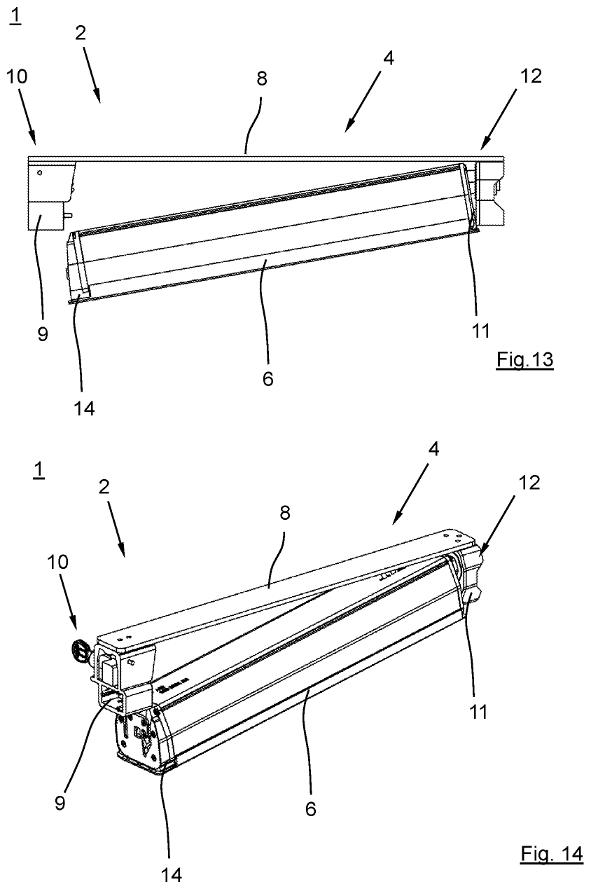

FIG. 13 shows a side view from the left of an electric bicycle in accordance with the invention in the region of the drive battery during removal of the battery;

FIG. 14 shows a perspective view of the electric bicycle of FIG. 13 in the region of the drive battery during removal of the battery;

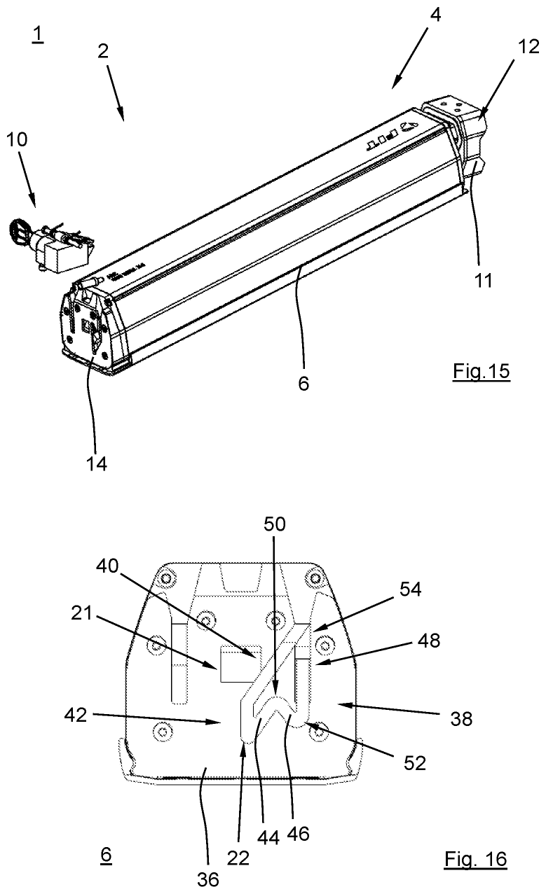

FIG. 15 shows a further perspective view of the electric bicycle of FIG. 13 in the region of the drive battery during removal of the battery;

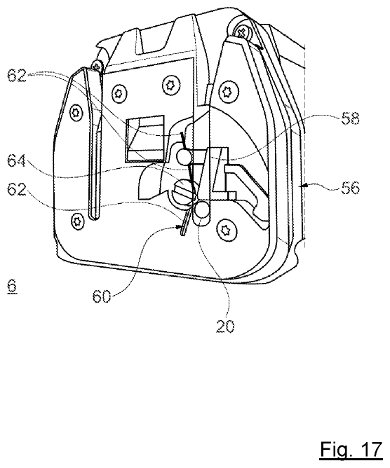

FIG. 16 shows an individual view of an end plate of the drive battery according to a second exemplified embodiment;

FIG. 17 shows an individual view of an end plate of the drive battery according to a third exemplified embodiment in a completely locked position;

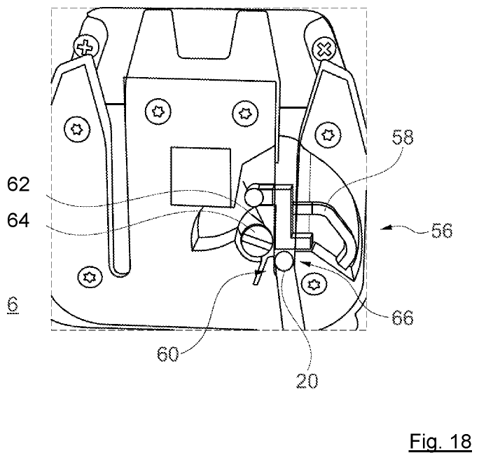

FIG. 18 shows an individual view of the end plate of FIG. 17;

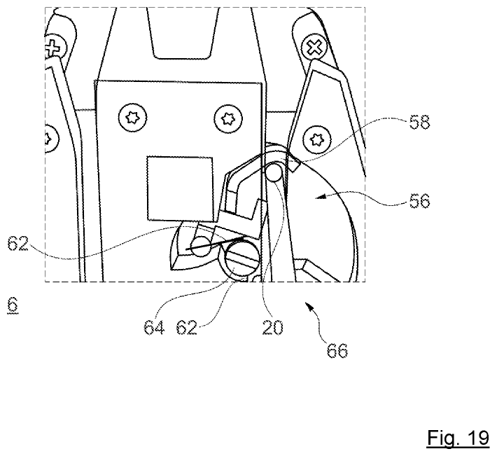

FIG. 19 shows an individual view of the end plate of FIG. 17 after unlocking of the lock in an intermediate position, and

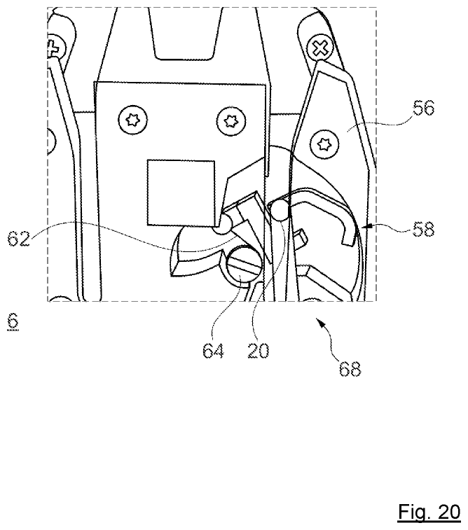

FIG. 20 shows an individual view of the end plate of FIG. 17 in the removal position;

FIG. 1 shows a side view from the left of an electric bicycle 1 in accordance with the invention having a schematically illustrated bicycle frame 2 in the region of a drive battery 6 inserted into a frame-side battery holder 4, wherein the drive battery 6 is received in the bicycle frame 2 by means of the battery holder 4. The battery holder 4 has a frame-side mounting base plate 8 with two end sections, wherein a lock 10 is arranged on an end section 9, and a pivot-in part 12 with an electrical contact region is provided on the second end section 11. The drive battery 6 has an end plate 14 on the end face.

FIG. 2 shows a perspective view of the electric bicycle 1 of FIG. 1 in the region of the drive battery 6 with battery holder 4.

A further perspective view according to FIG. 3 shows the drive battery 6 without mounting base plate 8 with schematically illustrated lock 10 and pivot-in part 12.

A primary locking arrangement of the drive battery 6 on the bicycle frame 2 is provided by means of the lock 10. According to FIGS. 1 to 3, the drive battery 6 is completely inserted, locked by means of lock 10 and the electric bicycle 1 is ready to ride.

According to FIG. 4, which shows an individual view of the end plate 14 of the drive battery 6, a secondary locking arrangement 16 is provided. By means of this secondary locking arrangement 16, the drive battery 6 can be fixed in an intermediate position. The secondary locking arrangement 16 is provided by means of a secondary locking bar 20 which is guided in a guide track 18 or a guide link. The secondary locking bar 20 is designed as a cylindrical locking pin. The guide track 18 is a heart-shaped track or heart-shaped curve and forms bistable positions for the secondary locking bar 20. The secondary locking bar 20 can be moved laterally in the guide track 28 by means of the force of a spring, so that it can reach the removal track section 32 of the guide track. In the lower position, the secondary locking bar 20 is prevented, by means of a stop element 24, from deflecting to the right by reason of the spring bias.

The guide track 18 is arranged next to an engagement point 21 of the lock 10. The guide track 18 has a lower end position 22 and an upper end position 24 for the secondary locking bar 20. The guide track 18 is triangular in sections and has a vertical guide track region 26, a lower transition region 28, an upper transfer region 30 and a removal track section 32.

The secondary locking bar 20 is located in the lower end position 22 of the guide track 18 when the drive battery 6 is completely locked and is arranged in its operating position, as shown in FIGS. 1 to 4. While a removed drive battery is being mounted, the secondary locking bar is moved along the removal track section 32 and the lower transition region 28 of the guide track 18 to this lower end position 22.

According to FIGS. 5 to 8, which show a side view and two perspective views of the battery region as well as a detailed view of the end plate 14, the drive battery 6 is moved to an intermediate position after actuation of the lock 10. By means of the secondary locking arrangement 16, the drive battery 6 is fixed in the intermediate position. According to FIG. 8, in this intermediate position, the secondary locking bar 20 is held for this purpose in a form-fitting manner in the upper end position 24 of the guide track 18.

As can be seen in FIGS. 9 to 12, which show a side view and two perspective views of the battery region as well as a detailed view of the end plate 14, the secondary locking arrangement 16 can be actuated to a removal position in order to remove the drive battery 6 by means of a relative movement of the drive battery 6 relative to the bicycle frame 2. The secondary locking arrangement 16 is unlocked after actuation of the primary locking arrangement, i.e. the lock 10, by means of a movement of the drive battery 6 by the rider in the direction opposite to its removal direction (in the direction of the arrow). In this case, the drive battery 6 is moved by the rider from the intermediate position partially back into the bicycle frame 2. The secondary locking bar 20 can be moved laterally in the guide track 28 by means of spring force, so that in this case it reaches the removal track section 32 of the guide track. In this case, the secondary locking bar 20 has been prevented, by means of a stop element 34, from deflecting to the right by reason of the spring bias. As a result, the secondary locking arrangement 16 is unlocked and the drive battery 6 can be removed. The drive battery 6 is now completely unlocked and can be removed from or taken off the bicycle frame 2. In this case, it is advantageous that the drive battery 6 can be removed using one hand. This is illustrated in FIGS. 13 to 15.

In the case of an alternative end plate 36 of a second exemplified embodiment of the invention, as illustrated in FIG. 16, a guide track 38 is approximately W-shaped at least in sections. In this case, the guide track 38 is designed as an inverse heart-shaped curve. The guide track 38 has an insertion track section 40, a transfer region 42 angled thereto, with two transfer track sections 44, 46, and has a removal track section 48. The secondary locking bar on the frame side (not illustrated) is acted upon in the direction of the transfer region 42 by means of the force of a spring so that the drive battery 6 can be moved to an intermediate position and, after a relative movement of the drive battery 6, to a removal position. In the completely locked position, the secondary locking bar is located in the lower end position 22. In the intermediate position, the secondary locking bar is located in a stable intermediate position 50. After the relative movement of the drive battery 6, the secondary locking bar is spring-biased to a removal position 52 so that it can move freely along the removal track section 48 for battery removal. During insertion of the battery, the secondary locking bar moves to its lower end position 22 via the insertion track section 40. A stop obstacle 54 prevents the secondary locking bar from moving into the removal track section 48 during insertion of the battery.

In the case of an end plate 56 of a third exemplified embodiment of the invention, as illustrated in FIGS. 17 to 20, the guide track 58 is arranged in a rotatable manner.

FIGS. 17 and 18 each show an individual view of the end plate 56 of the drive battery 6 in a completely locked position. The secondary locking bar 20 has been moved over an obstacle during locking of the drive battery 6 and is moved to a lower stop position 60.

FIG. 19 shows an individual view of the end plate 56 after the lock has been unlocked. After unlocking of the drive battery 6, the rotatable locking element (guide track) 56, which is spring-guided by means of a two-leg torsion spring 62, is rotated with pivot point 64 to the left against the spring force in an intermediate position 66. The secondary locking bar 20 has been moved to an intermediate position 66, wherein the drive battery 6 is secured and cannot fall out.

A relative movement of the drive battery 6 into the frame releases the force onto the rotatable locking element (guide track) 58 and this rotates back, as explained hereinafter according to FIG. 20.

FIG. 20 shows an individual view of the end plate 56 in the removal position, in which the secondary locking bar is located in the unlocking position 68. It should be noted in this exemplified embodiment that the spring force cannot push the secondary locking bar 20 to the unlocking position 68 on its own on account of the weight of the battery. The user must raise the drive battery 6 to do this.

What is disclosed is an electric bicycle 1 having a bicycle frame 2 and a drive battery 6 which can be fastened thereto, wherein a primary locking arrangement of the drive battery 6 on the frame 2 is provided by means of a lock 10, wherein, after actuation of the lock 10, the drive battery 6 can be moved to an intermediate position, and with a secondary locking arrangement 16 which fixes the drive battery 6 in the intermediate position. In accordance with the invention, the secondary locking arrangement 16 can be actuated to a removal position in order to remove the drive battery 6 by means of a relative movement of the drive battery 6 relative to the bicycle frame 2. What is also disclosed is a drive battery assembly for an electric bicycle 1.

### LIST OF REFERENCE SIGNS

1 electric bicycle
2 bicycle frame
4 battery holder
6 drive battery
8 mounting base plate
9 end section
10 lock
11 end section
12 pivot-in part
14 end plate
16 secondary locking arrangement
18 guide track
20 secondary locking bar
21 engagement point
22 lower end position
24 upper end position
26 vertical guide track region
28 lower transition region
30 upper transfer region
32 removal track section
34 stop element
36 end plate
38 guide track
40 insertion track section
42 transfer region
44 transfer track section
46 transfer track section
48 removal track section
50 intermediate position
52 removal position
54 stop obstacle
56 end plate
58 guide track
60 stop position
62 spring
64 pivot point
66 intermediate position
68 unlocking position

1. Electric bicycle having a bicycle frame and a drive battery which can be fastened thereto, wherein a primary locking arrangement of the drive battery on the bicycle frame is provided by means of a lock, wherein, after actuation of the lock, the drive battery can be moved to an intermediate position, and with a secondary locking arrangement which fixes the drive battery in the intermediate position, characterized in that the secondary locking arrangement can be actuated to a removal position in order to remove the drive battery by means of a relative movement of the drive battery relative to the bicycle frame.

2. Electric bicycle as claimed in claim 1, wherein the secondary locking arrangement is provided by means of at least one secondary locking bar which is guided in a guide track.

3. Electric bicycle as claimed in claim 1, wherein the secondary locking arrangement is unlocked by means of a movement of the drive battery in the direction opposite its removal direction.

4. Electric bicycle as claimed in claim 1, wherein the secondary locking arrangement is unlocked by means of a movement of the drive battery in the removal direction.

5. Electric bicycle as claimed in claim 1, wherein the guide track is designed as a guide slot or pocket-like groove.

6. Electric bicycle as claimed in claim 2, wherein the secondary locking bar has a locking pin which is cylindrical at least in sections.

7. Electric bicycle as claimed in claim 2, wherein the guide track forms bistable positions for the secondary locking bar.

8. Electric bicycle as claimed in claim 2, wherein the guide track has a lower end position and an upper end position for the secondary locking bar (20).

9. Electric bicycle as claimed in claim 2, wherein the secondary locking bar is located in the lower end position of the guide track when the drive battery is completely locked and is arranged in its operating position.

10. Electric bicycle as claimed in claim 8, wherein, after opening of the lock, the drive battery is moved to an intermediate position, in which the secondary locking bar is located in the upper end position of the guide track.

11. Electric bicycle as claimed claim 2, wherein the secondary locking bar can be moved to a removal position of the guide track by means of a movement of the drive battery relative to the intermediate position.

12. Electric bicycle as claimed in claim 2, wherein the secondary locking bar can be moved laterally in the guide track by reason of an application of force, preferably by means of the force of at least one elastic element, particularly preferably a spring.

13. Electric bicycle as claimed in claim 12, wherein a removal track section extends in the removal direction of the drive battery.

14. Electric bicycle as claimed in claim 2, wherein the guide track is approximately triangular in sections and has a vertical guide track region, a lower transition region and an upper transfer region.

15. Electric bicycle as claimed in claim 14, wherein the secondary locking bar has a force applied thereto in direction of the transfer region.

16. Electric bicycle as claimed in claim 14, wherein the secondary locking bar is acted upon in the direction of the transfer region by means of the force of at least one elastic element, preferably a spring.

17. Electric bicycle as claimed in claim 2, wherein the guide track is approximately W-shaped at least in sections.

18. Electric bicycle as claimed in claim 2, wherein the guide track can be pivoted.

19. Electric bicycle as claimed in claim 2, wherein the guide track is arranged next to an engagement point of the lock.

20. Electric bicycle as claimed in claim 2, wherein the guide track is allocated to the drive battery.

21. Electric bicycle as claimed in claim 2, wherein the drive battery has an end section which can be pivotably inserted in the bicycle frame, and the guide track is formed on an end section opposite to the pivotable end section.

22. Electric bicycle as claimed in claim 2, wherein the guide track is formed on the frame side.

23. Electric bicycle as claimed in claim 1, wherein the drive battery can be pivoted into a lower side of the down tube.

24. Drive battery assembly for an electric bicycle having a bicycle frame and a drive battery which can be fastened thereto, wherein a primary locking arrangement of the drive battery on the bicycle frame is provided by means of a lock, wherein, after actuation of the lock, the drive battery can be moved to an intermediate position, and with a secondary locking arrangement which fixes the drive battery in the intermediate position, characterized in that the secondary locking arrangement can be actuated to a removal position in order to remove the drive battery by means of a relative movement of the drive battery relative to the bicycle frame.
